(19) United States
(12) Patent Application Publication
(10) Pub. No.: US 2009/0182100 A1
(43) Pub. Date: Jul. 16, 2009

(54) Process for the production of polyethylene resin

(76) Inventors: Gerhard K. Guenther, Seabrook, TX (US); Steven D. Gray, Florence, KY (US); Tim J. Coffy, League City, TX (US)

Correspondence Address: FINA TECHNOLOGY INC, PO BOX 674412, HOUSTON, TX, 77267-4412, US

(21) Appl. No.: 12/008,740

(22) Filed: Jan. 14, 2008

(51) Int. Cl. C08F 2/01

(52) U.S. Cl. 526/65

(57) ABSTRACT

Process for the polymerization of ethylene to produce a polymer of enhanced long chain branching. Ethylene and hydrogen are introduced into a first reaction zone to produce an ethylene polymer having a first molecular weight distribution. The polymer from the first reaction zone is applied to a second reaction zone along with ethylene and a C₃-C₈ alpha-olefin monomer. The second reaction zone is operated to produce a copolymer having a second molecular weight distribution different from the first molecular weight distribution. A polymer fluff of bimodal molecular weight distribution is recovered from the second reaction zone and heated to melt the fluff and then extruded. Concomitantly with the heating and or extrusion, the polymer fluff is treated in order to enhance the long chain branching and reduce the melt index MI₅ of the polymer product.

### FIELD OF THE INVENTION

This invention relates to the polymerization of ethylene to produce a polyethylene resin having multimodal molecular weight distribution and more particularly to the polymerization of ethylene to produce a polymer fluff of enhanced long chain branching.

### BACKGROUND OF INVENTION

Polyethylene resins having a bimodal molecular weight distribution can be produced by multi-stage polymerization processes. In such multi-stage processes, polymer components of defined molecular weight distribution are produced in sequential polymerization, stages to arrive at a final product having the desired multi-modal molecular weight distribution. The polymer fluff can be extruded to produce a polymer product which ultimately can be used in various processes such as blow molding or extrusion molding to produce containers or other molded products or processes involving linear or multi-dimensional orientation to produce oriented products as fibers and films.

Significant physical characteristics of polyethylene polymers include the molecular weight distribution, MWD (a ratio of the weight average molecular weight, M_{w}, to the number average molecular weight, Mₙ) which can be monomodal or multimodal, and shear response as determined by the ratio of melt indices as determined in accordance with standard ASTM D1238. For example, the shear response, SR5, is the ratio of the high load melt index (HLMI) to the melt index MI₅. The various melt indices are conventionally reported in terms of melt flows in grams/10 minutes (g/10 min.) or the equivalent measure as expressed in terms of decigrams/minute (dg/min.). The polymer fluff withdrawn from the last stage of the polymerization system may be separated from the diluent in which the polymerization reaction proceeds, and then melted and extruded to produce particles of the polymer product, typically in the nature of pellets having dimensions of about ⅛-¼″ which then are ultimately used to produce the polyethylene containers or other products as discussed above.

As noted above, olefin polymers are also characterized in terms of their molecular weights. Molecular weight characterizations commonly employed are the number average molecular weight Mₙ, the molecular weight of all the number of polymer molecules divided by the total number of moles, and of the weight average molecular weight, M_{w}, as determined by light scattering measurements of polymer solution or as a derived from the viscosity average molecular weight as a close approximation of the weight average molecular weight. The weight average molecular weight and the number average molecular weight of a polymer sample can be employed to arrive at molecular weight distribution of the polymer MWD; D defined by the ratio D=M_{w}/Mₙ.

The melt flow characteristics of an ethylene homopolymer or a co-polymer can be correlated with the degree of long chain branching of the polymer. Thus, for a given melt flow index MI₅ of the powder coming from the reactor, the value of MI₅ of the pellets is inversely proportional to the level of long chain branching. As described for example, in U.S. Pat. No. 6,433,103 to Gunther, et al, the level of long chain branching for a polymer can be quantified in terms of its flow activation energy Eₐ. As disclosed in this patent, a substantially linear polyethylene having low levels of long chain branching can be characterized by flow activation energy of about 6.25-6.75 Kcal/mol. A corresponding polyethylene having a significant degree of long chain branching can be characterized by a flow activation energy Eₐ of about 7.25-9.0 Kcal/mol.

### SUMMARY OF INVENTION

In accordance with the present invention there is provided a process for the polymerization of ethylene to produce an ethylene polymer having a desired enhanced long chain branching. In carrying out the invention, ethylene and hydrogen are introduced into a first reaction zone in the presence of a polymerization catalyst under polymerization conditions effective to produce an ethylene polymer having a first molecular weight distribution. The polymer and hydrogen are recovered from the first reaction zone and applied to a second polymerization reaction zone. Ethylene and a C₃-C₈ alpha-olefin monomer are introduced in the presence of a catalyst system into a second reaction zone. The second reaction zone is operated under polymerization conditions effective to produce an ethylene-C₃-C₈ olefin copolymer having a second molecular weight distribution which is different from the first molecular weight distribution. A polymer fluff having bimodal molecular weight distribution is recovered from the second polymerization reaction zone and heated to a temperature sufficient to melt the polymer fluff. The molten polymer fluff is then extruded to produce particles of a polyethylene polymer product having multi-modal molecular weight distribution. Concomitantly with one or both of the heating and extrusion procedures, the polymer fluff is treated in order to enhance the long chain branching thereof and reduce the melt index MI₅ of the polymer product.

The first and second reaction zones may be of any suitable type effective for the production of bimodal molecular weight distribution polymers and in one embodiment of the invention take the form of first and second continuously stirred liquid reactors connected in series. In one aspect of the invention, the ethylene and hydrogen are introduced into the first reaction zone in the amount to provide a hydrogen to ethylene mole ratio of at least 2.0 and more specifically a hydrogen to ethylene mole ratio within the range of 3.0-5.5.

In one embodiment of the invention, the polymer fluff is treated to enhance long chain branching by the introduction of a free radical initiator into the polymer fluff prior to the extrusion of the polymer fluff as described above. In a further aspect of the invention, the component produced in the second reaction zone has a higher average molecular weight than the average molecular weight of the polymer produced in the first reaction zone.

In a further aspect of the invention, the difference between the melt index of the ultimate polymer product and the melt index MI₅ of the polymer fluff recovered from the second polymerization zone is greater the corresponding difference between the melt index MI₅ of the polymer fluff and the polymer product produced without the treatment of the polymer fluff to enhance the long chain branching thereof.

In yet another aspect of the invention, a mixture of hydrogen and ethylene is vented from the second reaction zone. The ratio of hydrogen to ethylene vented from the second reaction zone is greater than the corresponding ratio of hydrogen to ethylene which would be vented from the second reaction zone for a polymer product produced without the treatment of the polymer fluff to enhance the long chain branching thereof.

### BRIEF DESCRIPTION OF DRAWINGS

FIG. 1 of the drawing is a schematic illustration of a process for the polymerization of ethylene and a comonomer in a multi-stage system suitable for implementation of the present invention.

FIG. 2 is a graph showing the relationship between the concentration of a peroxide free radical inhibitor incorporated into a polymer fluff and the melt index of the polymer.

FIG. 3 is a graph showing the relationship between the concentration of the peroxide free radical inhibitor and the breadth parameter of the polymer.

### DETAILED DESCRIPTION OF THE INVENTION

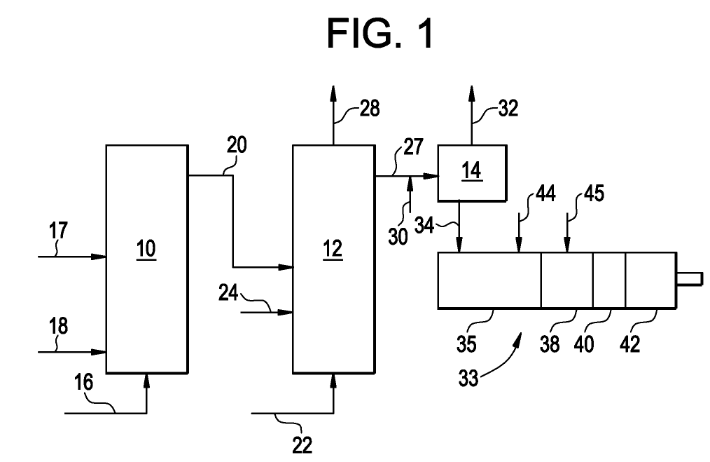

The invention may be carried out employing any suitable multi-stage reaction system for the sequential homo-polymerization and co-polymerization of ethylene. A suitable reaction system is illustrated in FIG. 1 which comprises a multi-stage reaction system having a pair of series connected continuously stirred reactors, (CSTR) together with a suitable recovery system. More particularly, and as illustrated in FIG. 1, there is shown an initial continuously stirred reactor 10 in series with a second continuously stirred reactor 12 and a recovery system 14 connected to the outlet of reactor 12. As shown in FIG. 1, reactor 10 is provided with an input line 16 through which ethylene feed in a suitable diluent such as hexane or heptane is supplied. In addition, reactor is provided with an input line 17 through which hydrogen is supplied. The reactor 10 may be of any suitable configuration, but in one embodiment takes the form of a multi-stage vertical reactor having an internal vertical impeller (not shown) which provides for continuous stirring of the reaction medium comprising ethylene, solvent and hydrogen as introduced into the reactor. A suitable polymerization catalyst such as a metallocene based catalyst system, a Ziegler-Natta catalyst system or a chromium based catalyst system of the type as disclosed in U.S. Pat. No. 6,218,472 is introduced into the reactor. The catalyst system may be incorporated into the feed stock supplied through line 16 or alternatively it may be introduced through a separate line 18.

The polymerization reaction in the first reactor is carried out under conditions effective to produce an ethylene homopolymer having a desired molecular weight distribution. The polymer product is recovered from the first reactor through a line 20 and supplied through line 20 to the second stage reactor which takes the form of CSTR reactor similarly as reactor 10. In addition ethylene and a C₃-C₈ alpha olefin comonomer are introduced into the second reactor in a suitable diluent such as hexane or heptane through line 22. A suitable catalyst system as described previously is introduced into the second reactor in the ethylene co-monomer feed stream or separately through a catalyst inlet line 24. The polymerization in the second reactor is carried out under polymerization conditions effective to produce a second polymer component comprising an ethylene-C₃-C₈ alpha olefin co-polymer which has a molecular weight distribution which is different from the molecular weight distribution of the polymer produced in the first reactor. The resulting polymer product has a bimodal molecular weight distribution and is withdrawn from reactor 12 through line 27. A mixture of hydrogen and unreacted ethylene is vented from reactor 12 through an overhead vent line 28. This gaseous mixture may be recycled to the first reactor or may be otherwise disposed of in a suitable recovery facility.

The product from the second reactor is supplied through line 27 to the concentration and recovery system 14 in which the multi-modal polymer fluff is extracted. The diluent and unreacted monomer are recovered from the recovery system 14 through line 32 and applied to a suitable purification and recovery system (not shown) from which they may be recycled to the reactor 12 or disposed of in a suitable manner. Typically the product stream flowing through line 27 from the second reactor to the recovery system is contacted with a suitable deactivator through an inlet line 30 in order to terminate the polymerization reaction as the product is supplied to recovery system 14.

The product stream containing the multi-modal polyethylene fluff, which is now substantially free of gaseous ethylene, is supplied through line 34 to an initial feed section 35 incorporating a heater of a polymer die-extrusion system 33, comprising, in addition, an extruding and mixing system 38 a downstream cooler 40 and a die 42. Within the feed section 35, the polymer fluff is heated to a temperature sufficient to melt the fluff and is thereafter passed to the extrusion mixing section 38 in which the molten polymer fluff is extruded to ultimately produce particles of the polymer product having multi-modal molecular weight distribution. A treating agent is incorporated into the section 35 through line 44 or into the section 38, through line 45, or through both of these lines, in order to provide for the enhanced long chain branching of the polymer product. In one aspect of the invention, a free radical initiator is introduced into the polymer fluff prior to applying the heated polymer fluff to the extruder. Thus the free radical initiator may be introduced into the section 35 via line 44. The free radical initiator may also be introduced into the section 38 via line 45. Once the molten polymer is extruded, it is cooled and then die cut in die 42 to form particles which are discharged from the product side of the extruder die system. Suitable agents which function as free radical initiators include peroxides, concentrated oxygen, air, and azides. Such free radical initiators including organic peroxides such as dialkyl and peroyketal type peroxides are disclosed in U.S. Pat. No. 6,433,103 to Guenther et al. As disclosed in this patent, an especially suitable, commercially available dialkyl peroxide includes 2,5 dimethyl-2,5,di(t-butylperoxy)hexane while suitable peroxyketal peroxides based on t-butyl and t-amyl type peroxides which are commercially available products.

The peroxide can be added to the polyethylene fluff or powder prior to introduction into the extrusion system 33. In such cases, the peroxide should be thoroughly mixed or dispersed throughout the polymer before being introduced into the extruder. Alternatively, as noted previously, the peroxide can be injected into the polyethylene melt within the feed section 35 or mixing section 38 of the extruder via line 44 or 45, respectively. The peroxide is usually added as a liquid, although the peroxide may be added in other forms as well, such as a peroxide coated solid delivery. The peroxide may also be added or combined with the polyethylene prior to or after the polyethylene is fed into the extruder. It can be beneficial to add liquid peroxide to the melt phase of the polyethylene within the extruder to ensure that the peroxide is completely dispersed. The peroxide may be introduced into the extruder through any means known to those skilled in the art, such as by means of a gear pump or other delivery device. If oxygen or air is used as the initiator, these can be injected into the extruder within the polyethylene melt.

The amount of peroxide or initiator necessary to achieve the desired properties and processability may vary. The amount of peroxide or initiator is important, however, in that too little will not achieve the desired effect, while too much may result in undesirable products being produced. Typically, for peroxides, the amounts used are from about 5 to about 100 ppm, with from about 5 to 50 ppm being more typical. More specifically, the amount of peroxide used may range from about 5 to about 40 ppm.

As disclosed in the above mentioned Guenther et al patent, the organic peroxide or other treating agent can be incorporated into the fluff prior to extrusion or injected into the polymer melt during the extrusion process. Thus the peroxide may be combined with the polymer fluff prior to or after the polymer is supplied to the extruder. For a further description of suitable treating agents which may be used in carrying out the invention and their matter of incorporation into the polymer product, reference is made to the aforementioned U.S. Pat. No. 6,433,103 to Guenther et al., the entire disclosure of which is incorporated herein by reference.

Another treatment procedure which may be used to treat the polymer fluff to enhance long chain branching involves the application of radiation such as disclosed in the aforementioned patent to Guenther, and also in U.S. Pat. No. 7,169,827 to Debras et al. As disclosed in the Debras et al. patent, the radiation to enhance long chain branching may be carried out with an electron beam having an energy level of at least 5 Mev at a radiation dose of 10 Kgray. The radiation of the polymer at the suitable energy level and dosage in combination with mechanically processing the irradiated polymer melt forms long chain branches in the polymer molecules. The high energy radiation may be applied during heating of the polymer fluff or during extrusion of the molten polymer or both. For a further description of suitable radiation procedures which may be employed to enhance long chain branching in carrying out the present invention, reference is made to the forementioned U.S. Pat. No. 7,169,827, the entire disclosure of which is incorporated herein by reference.

As discussed in the aforementioned patent to Guenther et al, the long chain branching of a polymer can be characterized in terms of shear response or more specifically the ‘a’ parameter from a Carreau-Yasuda fit of a frequency sweep. Rheological breadth refers to the breadth of the transition region between Newtonian and power-law type shear rate dependence of viscosity. The rheological breadth is a function of the relaxation time distribution of the resin, which in turn is a function of the resin's molecular architecture. It is experimentally determined assuming Cox-Merz rule by fitting flow curves generated using linear-viscoelastic dynamic oscillatory frequency sweep experiments with a modified Carreau-Yasuda (CY) model,

η=η₀[¹⁺(λγ^{)a}]ⁿₐ^{−1}

wherein
γ=viscosity (Pa s)
γ=shear rate (1/s)
a=rheological breadth parameter [CY model parameter which describes the breadth of the transition region between Newtonian and power law behavior].
λ=relaxation time in sec [CY model parameter which describes the location in time of the transition region].
η₀=zero shear viscosity (Pa s) [CY model parameter which defines the Newtonian plateau]
n=power law constant [CY model parameter which defines the final slope of the high shear rate region]
   To facilitate model fitting, the power law constant (n) is held to a constant value (n=0). Experiments may be carried out using a parallel plate geometry and strains within the linear viscoelastic regime over a frequency range of 0.1 to 316.2 sec.sup.-1. Frequency sweeps can be performed at three temperatures (170° C., 200° C. and 230° C.) and the data then shifted to form a mastercurve at 190° C. using known time-temperature superposition methods.

For resins with no differences in levels of long chain branching (LCB), it has been observed that the rheological breadth parameter (a) is inversely proportional to the breadth of the molecular weight distribution. Similarly, for samples which have no differences in the molecular weight distribution, the breadth parameter (a) has been found to be inversely proportional to the level of long chain branching. An increase in the rheological breadth of a resin is therefore seen as a decrease in the breadth parameter (a) value for that resin. This correlation is a consequence of the changes in the relaxation time distribution accompanying those changes in molecular architecture.

The level of long chain branching of a polymer can be quantified in terms of the resin's flow activation energy (Eₐ). The time dependent shifts (e.g., horizontal shift of modulus or stress versus frequency) required to form a mastercurve from the flow curves at 170° C., 200° C. and 230° C. can be used to calculate the flow activation energy using the well known temperature dependence of the linear viscoelastic properties in the form of the Arrhenius equation:

$${α}_{T} = exp ( \frac{{E}_{a}}{R} ( \frac{1}{273 + T} - \frac{1}{273 + T ∘} )$$

wherein
Eₐ=flow activation energy (kcal/mol)
T=temperature of the data being shifted
Tₒ=reference temperature
R=the Gas Constant
^{α}_{T}=the shift factor required to superimpose the flow curves at each temperature to the reference temperature (Tₒ)

The flow activation energy can be solved using the values of the shift factor required to overlap the flow curve at temperature, T, to that of the flow curve at temperature, Tₒ. The flow activation energy, Eₐ, represents the activation energy barrier associated with the energy required to create a hole big enough for a molecule to translate into during flow. This general definition of Eₐ, suggests its relationship or sensitivity to changes in molecular architecture such as those associated with changes in levels or types of long chain branching. As disclosed in the Guenther et al patent, polyethylene made using a chromium catalyst having a flux flow activation energy, Eₐ, in the range of 7.25±0.50 Kcal/mol, represents a significant amount of long chain branching. A more linear polyethylene made using Ziegler-Natta type catalysts having a similar polydispersity has very low levels of long chain branching indicated a fluff flow activation energy, E_{a,} of 6.5±0.25 kcal/mol.

In the present invention, the flux flow activation energy of the polymer fluff is employed as a long chain branching index to provide a quantative measure of long chain branching of the fluff after treatment. In one embodiment of the invention the polymer fluff is treated to provide a long chain branching index (equivalent to the flow activation energy,Eₐ of at least 7.0 and more specifically at least 7.25 at the conclusion of the enhancement treatment.

Regardless of the mode of operation employed to enhance long chain branching of the polymer, the increase in the level of long chain branching results in a reduction in the melt index MI₅ of the polymer product. This reduction in the melt index is effected without a corresponding change in the polymer molecular weight. Enhancing long chain branching of the polymer in the course of the extrusion of the polymer to arrive at the ultimate pelletized product, thus enables the polymerization reaction to be carried out under conditions to provide a higher melt index MI₅ of the original polymer fluff (corresponding to a reduced molecular weight), for a given melt index MI₅ of the final pelletized product. Therefore, the decrease in the melt flow index MI₅ when going from the polymer fluff to the polymer product can be greater than would otherwise be the case; that is, when long chain branching is not introduced in the extrusion process in accordance with the present invention. This, in turn, allows the process to be carried out at a higher hydrogen-to-ethylene ratio than would be the case without the incorporation of long chain branching during the extrusion process. This increase in the hydrogen-to-ethylene ratio results in less headspace venting in the second liquid filled reactor. This in turn results in a reduction in the amount of ethylene monomer lost in the process with a corresponding reduction in the cost of ethylene employed in the polymerization process.

As indicated previously, the practice of the present invention enables the polymer fluff to polymer pellet MI₅ melt drop to be greater than would be the case for a comparable process carried without enhancement of long chain branching. This, in turn, allows for a higher hydrogen-to-ethylene mole ratio to be targeted in the second reactor. Since the hydrogen-to-ethylene mole ratio in the second reactor 12 is directly related to the hydrogen-to-ethylene mole ratio in the first reactor 10, although influenced by other factors such as the ethylene feed through line 22 into the second reactor, this condition, in turn, relates to the mole ratio of hydrogen-to-ethylene introduced into the reactor. The introduction of ethylene and hydrogen into the first reactor 10 may be controlled to provide a hydrogen-to-ethylene mole ratio of at least 2.0 and, more specifically, a hydrogen-to-ethylene mole ratio of at least 3.0.

The hydrogen-to-ethylene mole ratio in the second reactor is, as stated earlier, related to the initial hydrogen-to-ethylene mole ratio in the first reactor. Additional influencing factors are the ratio of hydrogen-to-polyethylene withdrawn from the first reactor and supplied to the second reactor, as well as the amount of ethylene separately supplied to the second reactor. Depending upon these parameters, the hydrogen-to-ethylene mole ratio to be arrived at in the second reactor may be at least 0.05. Higher hydrogen-to-ethylene mole ratios in the second reactor of at least 0.1, and further, at least 0.15 may be observed. The higher ratio of hydrogen-to-ethylene in the second reactor is associated with a reduction in venting of the gaseous head space in the second reactor with an attendant reduction in ethylene loss from the second reactor.

As noted previously, the copolymer produced in the second reaction zone 12 has a higher molecular weight than the average molecular weight of the polyethylene homopolymer produced in the first reaction zone. The average molecular weight MW₁ in the first reaction zone may be within the range of 25,000 to 50,000 and the molecular weight MW₂ in the second reaction may be within the range of 450,000 to 600,000, providing a range of MW₂/MW₁ from 9 to 26 with a typical value of about 15. The average molecular weight of polymers produced in the first and second reaction zone result in a ratio of the average molecular MW₂ to the average molecular weight MW₁ produced respectively in the second and first reaction zones is at least 9. More specifically, the ratio MW₂/MW₁ may be at least 10 or, alternatively, at least 14. The molecular weight relationships described above are expressed in terms of the weight average molecular weight for the polymer products involved. However, similar comparative relationships between the polymers produced in the first and second reaction zone are found for the number average molecular weight values also.

Table 1 illustrates the relationship between long chain branching as indicated by the flow activation energy and peroxide treated polymer fluffs at peroxide levels ranging from 0 (no treatment) to 100 parts per million (ppm). Table 1 also shows the molecular weight characteristics and melt flow indices for the polymers. The melt index (MI₅) for the polymer fluff was 0.42 g/10 minutes and the polymer fluff to polymer pellet melt drop with a melt index (MI₅) increased from 48% for a polymer without treatment to 90% for the polymer fluff treated with 100 ppm peroxide.

TABLE 1

| | Peroxide (ppm) | | | |
|---|---|---|---|---|
| | 0 | 10 | 50 | 100 |
| Mn | 12,745 | 12,781 | 12,729 | 12,911 |
| Mw | 268,792 | 277,422 | 271,280 | 285,778 |
| Mz | 1,605,348 | 1,687,438 | 1,681,209 | 1,855,739 |
| Polydispersity | 21 | 22 | 21 | 22 |
| MI5 (g/10 min) | 0.22 | 0.13 | 0.08 | 0.04 |
| % Melt Drop | 48 | 69 | 81 | 90 |
| (Fluff MI5 = 0.42) | | | | |
| Zero Shear | 3.11E+06 | 7.57E+05 | 2.08E+07 | 1.25E+08 |
| Viscosity (Pa s) | | | | |
| Relaxation Time | 2.494 | 0.798 | 12.802 | 58.422 |
| (s) | | | | |
| Breadth | 0.235 | 0.191 | 0.155 | 0.135 |
| Parameter (a) | | | | |
| Power Law | 0 | 0 | 0 | 0 |
| Const (n) | | | | |
| Flow Activation | 6.89754 | 7.79618 | 8.5084 | 7.59542 |
| Energy (kJ/mol) | | | | |

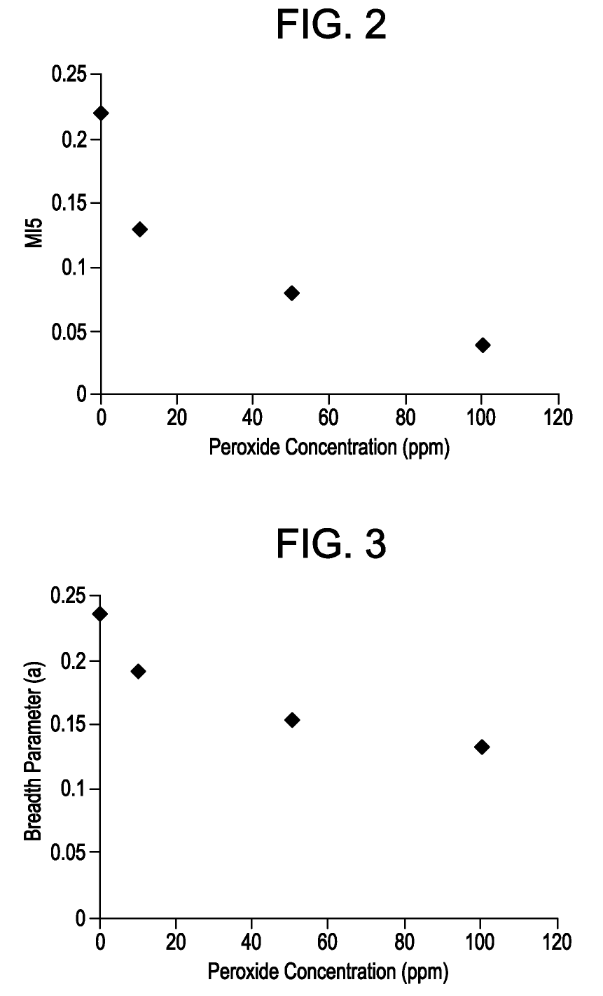

The impact of the peroxide concentration employed in treating the polymer fluffs versus the melt index (MI₅) and the Breath Parameter (a), as reported in Table 1, are shown in FIGS. 2 and 3 respectfully. FIG. 2 is a plot of the melt index (MI₅) on the ordinate versus the peroxide concentration on the abscissa. FIG. 3 is a similar plot of the Breath Parameter (a), as shown in Table 1, plotted on the ordinate versus the peroxide concentration as plotted on the abscissa. As can be seen from examination of FIGS. 2 and 3, both the melt flow index and the Breath Parameter (a) decrease substantially with increasing peroxide concentration.

Having described specific embodiments of the present invention, it will be understood that modifications thereof may be suggested to those skilled in the art, and it is intended to cover all such modifications as fall within the scope of the appended claims.

1. A process for the production of a polyethylene resin having a bimodal molecular weight distribution comprising:
(a) introducing ethylene and hydrogen into a first reaction zone in the presence of a catalyst system under polymerization conditions to produce an ethylene polymer having a first molecular weight distribution;
(b) recovering said polymer and hydrogen from said first reaction zone and supplying said polymer and hydrogen to a second polymerization reaction zone;
(c) introducing ethylene and a C₃-C₈ olefin monomer into said second reaction zone in the presence of a catalyst system under polymerization conditions to produce a second polymer comprising an ethylene C₃-C₈ olefin co-polymer having a second molecular weight distribution which is different from said first molecular weight distribution;
(d) recovering a polyethylene polymer fluff having bimodal molecular weight distribution from said second polymerization reaction zone;
(e) heating the polymer fluff recovered from said second polymerization reaction zone to a temperature sufficient to melt said fluff;
(f) extruding said heated polymer fluff to produce particles of polyethylene polymer product having a multimodal molecular weight distribution; and
(g) concomitantly with at least one of the heating and extrusion of said polymer fluff, treating said polymer fluff to enhance the long chain branching thereof and reduce the melt index, MI₅, of said polymer product, wherein the second polymerization reaction zone is operated at a hydrogen to ethylene molar ratio that is greater than a hydrogen to ethylene molar ratio of an identical process absent the treating of the polymer fluff.

2. The process of claim 1 wherein said first and second reaction zones are provided by first and second continuously stirred liquid reactors connected in series.

3. The process of claim 2 wherein ethylene and hydrogen are introduced into said first reaction zone in an amount to provide a hydrogen to ethylene mole ratio of at least 2.0.

4. The process of claim 3 wherein said hydrogen to ethylene mole ratio is within the range of 3.0-5.5.

5. The process of claim 1 wherein said polymer fluff is treated in subparagraph (g) to provide a long chain branching index for said polymer fluff of at least 7.

6. The process of claim 5 wherein said polymer fluff is treated in subparagraph (g) to provide a long chain branching index for said polymer fluff of at least 7.25.

7. The process of claim 1 wherein said polymer fluff is treated in subparagraph (g) by the introduction of a free radical initiator into said polymer fluff prior to extruding said polymer fluff.

8. The process of claim 1 wherein the difference between the melt index MI₅ of the polymer product and the melt index MI₅ of the polymer fluff recovered in subparagraph (e) is greater than the corresponding difference between the melt index MI₅ of the polymer fluff and a polymer product produced without the treatment of the polymer fluff to enhance the long chain branching thereof.

9. The process of claim 1 wherein the copolymer produced in said second reaction zone has an average molecular weight MW₂ which is higher than the average molecular weight MW₁ of the polymer produced in said first reaction zone.

10. The process of claim 9 wherein the ratio of the average molecular weight (MW₂) to the average molecular weight (MW₁) produced in said first reaction zone is at least 10.

11. The process of claim 10 wherein the ratio MW₂/MW₁ is at least 14.

12. The process of claim 1 further comprising venting a mixture of hydrogen and ethylene from said second reaction zone.

13. The process of claim 12 wherein the ratio of hydrogen to ethylene vented from said second reaction zone is greater than that of an identical process without the treatment of the polymer fluff to enhance the long chain branching thereof.

14. The process of claim 13 wherein said polymer fluff is treated to provide a long chain branching index for said polymer fluff of at least 7.

15. The process of claim 15 wherein said polymer fluff is treated to provide a long chain branching index for said polymer fluff of at least 7.25.

16. The process of claim 1 wherein the said ethylene and hydrogen are introduced into said reaction zone in an amount to provide to a hydrogen to ethylene mole ratio in said first reaction zone of at least 2.0 and further providing a hydrogen to ethylene mole ratio in said second reaction zone of at least 0.05.

17. The process of claim 16 further comprising venting a mixture of hydrogen and ethylene from said second reaction zone.

18. The process of claim 16 wherein the hydrogen to ethylene mole ratio in said second reaction zone is at least 0.1.

19. The process of claim 16 wherein the hydrogen to ethylene mole ratio in said first reaction zone is at least 3.0.

20. The process of claim 19 wherein the hydrogen to ethylene mole ratio in said second reaction zone is at least 0.15.
